(19) United States
(12) Patent Application Publication
(10) Pub. No.: US 2022/0068249 A1
(43) Pub. Date: Mar. 3, 2022

(54) Control Device and Method for a Musical Instrument

(71) Applicants: Joseph Goldberg, Bridgeport, CT (US); William Bracken, Duxbury, MA (US)

(72) Inventors: Joseph Goldberg, Bridgeport, CT (US); William Bracken, Duxbury, MA (US)

(21) Appl. No.: 17/008,686

(22) Filed: Sep. 1, 2020

(51) Int. Cl. G10H 3/18; G10D 1/08

(52) U.S. Cl. CPC G10H 3/181; G10D 1/085

(57) ABSTRACT

The present invention relates to a novel device and related method for a musician, performer in a band, or an ensemble, to stop, shut-off and/or disengage the signals created by their instrument electronically through grounding or disconnecting the instrument's connection to an audio generation device such as an amplifier, speaker, or other digital interface. The invention is exemplified by reference to an electric guitar connected to an amplifier, with the control device disrupting the electrical connection therebetween and incorporating a guitar pic for the control of the connection disruption. The control device may be implemented either by grounding the connection between the instrument or by disconnecting it completely using an electrical switch.

### FIELD OF INVENTION

The present invention relates generally to the field of control devices and methods for musical instruments. More specifically, the present invention relates to an insertable shut-off circuit for an electric instrument and related methods.

### BACKGROUND

Many musical performers use various forms of abrupt halts in their instrument playing as part of their performance, including complete stops, empty air stops, and silence for moments or extended periods. Typically, this requires special practice, actions with instrument paraphernalia and/or specific hand corrections performed by the musician.

These musical effects need to be precisely timed, and often must be coordinated with the remainder of the performers if done in an ensemble. As bands regularly change personnel, the timing of these interludes must often be re-learned repeatedly which can amount to a great deal of practice time.

Furthermore, due to the nature of electronic instruments, interference often produces undesirable lingering sounds during the stops, such as unpleasant screeching noises.

It is within this context that the present invention is provided, addressing ease of co-ordination, precision of the stop operation, and completely eliminating lingering sound effects during the stop.

### SUMMARY

The present invention relates to a novel device and related method for a musician, performer in a band, or an ensemble, to stop, shut-off and/or disengage the signals created by their instrument electronically through grounding or disconnecting the instrument's connection to an audio generation device such as an amplifier, speaker, or other digital interface.

The invention is exemplified by reference to an electric guitar connected to an amplifier, with the control device disrupting the electrical connection therebetween and incorporating a guitar pic for the control of the connection disruption. The control device may be implemented either by grounding the connection between the instrument or by disconnecting it completely using an electrical switch.

Thus, according to a first aspect of the present invention there is provided a control device for an electric guitar, the control device comprising: a male connector configured to connect to an electric guitar output port and receive a signal therefrom; a guitar pic connected to a first terminal of the male connector by one or more wires, the first terminal being proximal to a connected electric guitar when the control device is in use; and a female connector configured to connect to an amplifier, the female connector being connected to a second terminal of the male connector which is distal from an electric guitar when the control device is in use; wherein the guitar pic comprises a conductive tip forming part of the control device circuit such that, when the control device is connected between an electric guitar and an amplifier and the conductive tip of the pic is placed in contact with a ground connection, the control device grounds the output port and prevents signals received therefrom from being amplified.

Advantageously, the complete and abrupt absence of sound through the use of the control device enhances the musical presentation by clearly eliminating any unwanted noise, electrical interference or imperfections in the musicians timing. Once removed from contact, sound continues and a variety of effects can be achieved by stop/starts of sound, sound changes during silence times and/or restart in a differing manner.

The wiring of the pic is internal and not noticeable. The pic may optionally be separated from or attached to an electric guitar. Regardless, the pic should be easily reachable to an operator of the guitar and the connecting wires should be long enough that an operator can use the pic without being restricted by the length of the wire.

The pic can be decorative, the electronics within the pic are not noticeable and the musician treats it as standard.

According to a second aspect of the present invention, there is provided a control device for an electric guitar, the control device comprising: a male connector configured to connect to an electric guitar output port and receive a signal therefrom; a guitar pic connected to a first terminal of the male connector by one or more wires, the first terminal being proximal to a connected electric guitar when the control device is in use; and a female connector configured to connect to an amplifier, the female connector being connected to a second terminal of the male connector which is distal from an electric guitar when the control device is in use; wherein the guitar pic comprises an electrical switch and an actuatable trigger element on the guitar pic configured to, when the control device is connected between an electric guitar and an amplifier, cause the electric switch to move between a first position where the control device forms a closed circuit allowing signals to pass from the male connector to the female connector and a second position where the control device forms an open circuit and signals are prevented from passing from the male connector to the female connector.

As mentioned, the guitar pic may be attached to an electrical guitar.

Furthermore, the actuatable trigger is in the form of a low-profile button or pressure-sensitive switch.

According to a third aspect of the present invention, there is provided a related method for causing an abrupt halt in the sound of a musical instrument, the method comprising: causing, by an operator of the electrical instrument, a breaking or grounding of the connection between an input portion of the instrument and an audio output portion of the instrument, the breaking or grounding of the connection being controlled by the actuation of a trigger element or bringing a portion of a connection into contact with a grounded element.

### BRIEF DESCRIPTION OF THE DRAWINGS

Various embodiments of the invention are disclosed in the following detailed description and accompanying drawings.

FIG. 1 illustrates an overview of an example configuration of the present invention in an exploded perspective view.

FIG. 2 illustrates an internal components view of an example configuration of a specific feature of the first aspect of the present invention as disclosed.

FIG. 3 illustrates an internal components view of an example configuration of a specific feature of the first aspect of the present invention as disclosed.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention will now be described by referencing the appended figures representing some and/or various embodiments.

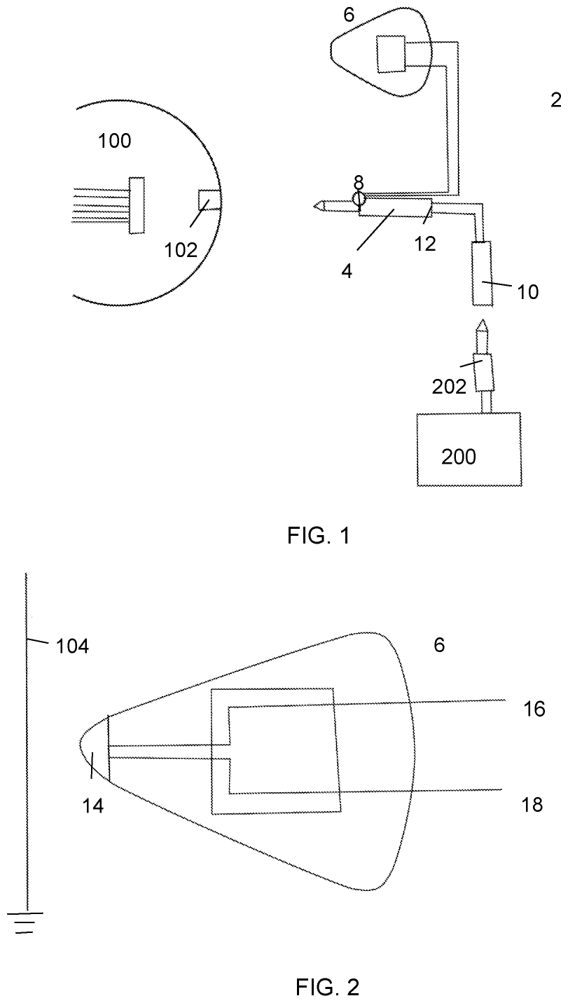

Referring to FIG. 1, an overview of an example configuration of the control device 2 of the present invention is shown in an exploded perspective view.

The control device 2 is illustrated positioned and ready to connect between an electric instrument 100, in the present example an electric guitar, and an audio generation device 200, in the present example an amplifier.

The control device 2 comprises a male connector 4 configured to connect to an electric guitar output port 102 and receive a signal therefrom. The signal would be a signal picked up from the electric guitar pickups based on changes in the magnetic field detected due to the electric guitar strings being plucked. The inner workings and possible implementations of electric guitars are well known to those skilled in the art and will not be elaborated on in detail herein.

The control device further comprises a guitar pic 6 having internal wiring connected to a first terminal 8 of the male connector 4, the first terminal 8 being proximal to the connected electric guitar 100 when the control device is in use. Specifically, the male connector 4 is inserted into the guitar output port 102 forming a connection for receiving the audio. The control device 2 further comprises a female connector 10 which is connected to a second terminal 12 of the male connector 4, the female connector 10 being configured to pass on any signals received from the electric guitar output port 102 to the amplifier 200. This configuration of the control device 200 uses standards jacks/ports which seamlessly slot in between the electric guitar 100 and the amplifier 200 using connection ports 102 and 202 which are already present and without requiring any other modifications or calibrating, forming a closed circuit with the control device 2 slotted between the electric guitar 100 and the amplifier.

The wiring of the control device 2 is such that a signal received form the electric guitar output 102 must travel through the internal wiring of the pic 6 before passing onto the second terminal 12 at the distal end of the male connector 4, then travelling through the connection between female connector 10 and amplifier jack 202. Advantageously, this creates a point in the connection between the electric guitar 100 and the amplifier 200 where the circuit can be grounded or broken. Furthermore, as a user of the electric guitar 100 will already be holding the pic 6 it is both convenient and ergonomic to place a trigger mechanism at this point in the circuit.

Advantageously, the complete and abrupt absence of sound through the use of the control device 2 enhances the musical presentation by clearly eliminating any unwanted noise, electrical interference or imperfections in the musician's timing.

While illustrated specifically with respect to the connection between an electric guitar and an amplifier, those skilled in the art will appreciate that the concept of inserting a control device for breaking or grounding a connection between a musical instrument and a sound generating device can be applied to any variety of electrical instruments, and should not be limited solely to a guitar and amplifier configuration. Thus, the present invention further relates to a generic method for breaking or grounding a connection between a musical instrument and a sound generation device as set out in the appended claims.

Returning to the operations of the control device 2, two specific configurations of the guitar pic 6 are provided herein for, respectively, grounding and breaking the connection between the guitar and the amplifier to allow a performer to precisely and easily halt the sound generated by their instrument.

Referring to FIG. 2, an internal components view of an example configuration of the guitar pic 6 of the present invention is disclosed which causes a halt to sound generated by the electric guitar via connecting a conductive tip 14 of the pic to ground.

The present embodiment of the invention takes advantage of the fact that electric guitars have strings and other components which are connected to ground in order to eliminate noise detected by the electric guitar pickups.

Thus, in the present example the guitar pic 6 comprises a conductive tip 14 forming part of the control device circuit. Specifically, the pic comprises an input wire 16 that is fed into the internal circuitry of the pic 6 via the first port 8 of the male connector 4 attached to the electric guitar 100. The input wire runs all the way to the tip of the pic, which is made of a low-resistance conductive material, such as for example copper. A second wire 18 then runs out of the copper tip, through to the back of the pic and then leads back to the first terminal 8 before continuing to the second terminal 12 and on to the amplifier 200 via female connector 10. In practice, this means that when the copper tip is not in contact with a grounded element a signal from the electric guitar can travel through the pic 6 and to the amplifier 200, but when the tip 14 is placed in contact with a grounded element, such as for example an electric guitar string 104, the signal will not flow to the amplifier 200, but will instead follow the path of least resistance to ground, having the effect that placing the tip 14 in contact with a guitar string 104 or other grounded element will immediately halt any sound produced by the electric guitar strings, since no signal is being amplified. Once removed from contact, sound continues and a variety of effects can be achieved by stop/starts of sound, sound changes during silence times and/or restart in a differing manner.

It should be noted that any type or shape of pic could be used in conjunction with control device 2. The wiring of the pic is internal and not noticeable. The pic may optionally be separated from or attached to an electric guitar. Regardless, the pic should be easily reachable to an operator of the guitar and the connecting wires should be long enough that an operator can use the pic without being restricted by the length of the wire. The pic can be decorative, the electronics within the pic are not noticeable and the musician treats it as standard.

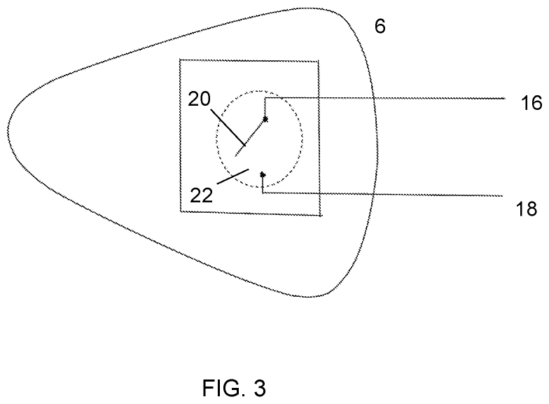

Referring to FIG. 3, an alternative embodiment of the guitar pic 6 of the present invention is shown, wherein the conductive tip 14 is replaced by a switch or gate 20 and an actuatable trigger element 22 for moving the switch 20 between an open position and a closed position.

The circuit path for the present embodiment is similar to the previous embodiment, with an input signal travelling into the pic via input wire 16 and out of the pic via output wire 18, however rather than grounding the connection, the present embodiment halts the audio signal by creating an open circuit when the switch 20 is in an open position. The pic 6 is operated by a trigger element in the form of a pressure sensitive switch or button 22 (illustrated above the circuitry via a dotted line) on its outer surface which, when actuated by an operator, will cause the switch 20 to move between open and closed positions, thereby applying controlled halts to the sound produced by the electric guitar.

The trigger 22 can be any form of actuatable trigger. Preferably it is low profile to increase user comfort and improve aesthetics. Optionally, the actuatable trigger 22 may be arranged as a press and release type trigger, wherein the switch 20 only remains in an open position for as long as a user holds the trigger 22.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A control device for an electric guitar, the control device comprising: a male connector configured to connect to an electric guitar output port and
receive a signal therefrom; a guitar pic connected to a first terminal of the male connector by one or more wires, the first terminal being proximal to a connected electric guitar when the control device is in use; and a female connector configured to connect to an amplifier, the female connector being connected to a second terminal of the male connector which is distal from an electric guitar when the control device is in use; wherein the guitar pic comprises a conductive tip forming part of the control device circuit such that, when the control device is connected between an electric guitar and an amplifier and the conductive tip of the pic is placed in contact with a ground connection, the control device grounds the output port and prevents signals received therefrom from being amplified.

2. A control device according to claim 1, wherein the guitar pic is attached to an electrical guitar.

3. A control device for an electric guitar, the control device comprising: a male connector configured to connect to an electric guitar output port and
receive a signal therefrom; a guitar pic connected to a first terminal of the male connector by one or more wires, the first terminal being proximal to a connected electric guitar when the control device is in use; and a female connector configured to connect to an amplifier, the female connector being connected to a second terminal of the male connector which is distal from an electric guitar when the control device is in use; wherein the guitar pic comprises an electrical switch and an actuatable trigger element on the guitar pic configured to, when the control device is connected between an electric guitar and an amplifier, cause the electric switch to move between a first position where the control device forms a closed circuit allowing signals to pass from the male connector to the female connector and a second position where the control device forms an open circuit and signals are prevented from passing from the male connector to the female connector.

4. A control device according to claim 3, wherein the guitar pic is attached to an electrical guitar.

5. A control device according to claim 3 or claim 4, wherein the actuatable trigger is in the form of a low-profile button or pressure-sensitive switch.

6. A method for causing an abrupt halt in the sound of a musical instrument, the method comprising: causing, by an operator of the electrical instrument, a breaking or grounding of the connection between an input portion of the instrument and an audio output portion of the instrument, the breaking or grounding of the connection being controlled by the actuation of a trigger element or bringing a portion of a connection into contact with a grounded element.
